(19) United States
(12) Patent Application Publication
(10) Pub. No.: US 2005/0277051 A1
(43) Pub. Date: Dec. 15, 2005

(54) Increased sensitivity, UV imageable photographic elements

(75) Inventors: Stephan J.W. Platzer, Longmeadow, MA (US); Howard A. Fromson, Stonington, CT (US)

Correspondence Address: Richard S. Roberts, P.O. Box 484, Princeton, NJ, 08542-0484, US

(73) Assignee: ANOCOIL CORPORATION

(21) Appl. No.: 10/857,990

(22) Filed: Jun. 1, 2004

(51) Int. Cl. G03C 5/18

(52) U.S. Cl. 430/175; 430/280.1

(57) ABSTRACT

The invention provides a photosensitive element which comprises a sheet substrate having coated thereon an actinic radiation sensitive imageable layer. The imageable layer has an admixture an aromatic diazonium salt having an anion, and having a weight average molecular weight of from about 15,000 to about 35,000. The aromatic diazonium salt is present in an amount of from about 1 weight % to about 9 weight % of the imageable layer. The composition also has a solid epoxy polymer having a weight average molecular weight of from about 2,000 to about 8,000. The coating weight of the imageable layer per area is preferably from about 0.3 to about 0.9 g/m². The imageable layer is sensitive to low levels of actinic irradiation, namely, from about 1 to about 40 mj/cm² in the UV region. The sensitivity is increased by heating the imageable layer before development. After imagewise exposure and aqueous development, an imaged element is obtained, which is useful for lithographic printing.

### BACKGROUND OF THE INVENTION

1. Field of the Invention

The present invention relates to negative working, actinic radiation sensitive compositions. More particularly, it relates to the preparation of imageable elements comprising an actinic radiation sensitive layer on a substrate. Such are useful as negative working lithographic printing plates.

2. Description of the Related Art

The art of lithographic printing depends on the immiscibility of grease and water, and the preferential affinity of a greasy ink by an image area of a printing plate, and a similar preferential affinity of an aqueous dampening fluid by a non-image area of a printing plate. Lithographic printing plates comprise a lithographically suitable support having a coating on at least one surface thereof comprising an actinic radiation sensitive composition. When the radiation sensitive composition is imagewise exposed through a transparency and developed, image and nonimage areas are formed on the surface. When the entire surface is then moistened with an aqueous solution, the image area repels the aqueous solution and the non-image area retains the aqueous solution. Upon subsequent application of a greasy ink, the image areas retain the ink whereas the moistened nonimage areas repel it. The ink on the image areas is then transferred to the surface of a material on which the image is to be reproduced, such as paper, cloth and the like, typically via an intermediary offset blanket or cylinder.

Depending on the nature of the radiation sensitive coating, the plate may directly reproduce the image on a transparency to which it is exposed, in which case it is termed a positive working printing plate, or it may produce an image complementary to the one to which it is exposed, in which case it is termed a negative working printing plate. In either case, the image area of the developed printing plate is oleophilic and the non-image area is hydrophilic. In the case of a negative working element which is exposed to radiation through a negative transparency, the radiation-sensitive material, commonly a diazonium compound, is caused to harden and thereby become insoluble in a developing composition applied to the element after radiation exposure. This is for the purpose of removing that part of the radiation-sensitive coating which, because it was protected from the radiation by the negative, was not radiation hardened. The hardened surface of a negative working printing plate will be the oleophilic surface compatible with the greasy ink and is called the image area. The surface from which the non-hardened radiation-sensitive material has been removed by the developer will be, or can be converted to, a hydrophilic surface having little affinity for the greasy ink and is called the nonimage area. The light-hardened surface of a negative plate is therefore oleophilic and will accept ink while the nonimage area which has had the coating removed through the action of a developer is desensitized and is therefore hydrophilic.

It is known to use light sensitive aromatic diazonium compounds for reproduction materials which are useful for making light-sensitive lithographic printing plates. When a composition containing the aromatic diazonium compound is applied on a hydrophilic support and exposed to light through a transparent negative original, only the exposed portions are rendered hydrophobic and oleophilic, that is, water repellent and ink receptive, and the unexposed portions can easily be removed with a developer solution whereby a negative image can be obtained. These light sensitive aromatic diazonium compounds are low-molecular weight compounds and hence if such a compound is used individually it is deposited in crystalline form which results in lowering the mechanical strength of the image obtained and makes long press runs difficult to attain. Accordingly, a binder resin is used as a carrier to compensate for any weakening of the mechanical strength. However, if materials other than the diazonium compound are incorporated into the light-sensitive layer there is a tendency to reduce the sharpness of the light-sensitive layer to development. According to the present invention, sensitivity to the radiation is increased by heating the imageable layer after exposure but before development. A very widely used type of lithographic printing plate has a light-sensitive coating applied to an aluminum base support.

Two main types of monomer compositions are commonly used in photopolymerization processes, acrylates and epoxies. It is widely recognized that the cationic photopolymerization of epoxy compositions is slower than free radical photopolymerization of acrylate monomers. For this reason, although cured epoxies generally have better physical properties than their acrylate counterparts, these materials are not commonly used for high speed applications such as rapid imaging techniques. There is currently a tendency toward the use of monochromatic light sources such as lasers and light emitting diodes for digital imaging applications. In general, these light sources produce less light emission than those from most common broad band UV irradiation sources.

The use of photoacid generators to crosslink epoxy materials is also well known. For example, U.S. Pat. No. 3,794,576 describes the use of monomeric diazonium salts to crosslink liquid epoxy materials. An example of such a diazonium salt is 2,5-diethoxy-4-(p-tolylthio)benzenediazonium hexafluorophosphate. The amount of the photoacid generator is between 0.1 and 5% by solid weight of the composition.

U.S. Pat. No. 4,104,072 claims a water developable lithographic printing plate which comprises a metal substrate with a middle layer of a water soluble diazonium salt and a top layer of a particular diazonium salt and water insoluble resin, which can be an epoxy resin. The anion to the diazonium salt in the top layer is 2-hydroxy-4-methoxy benzophenone sulfonate. This patent discloses a preferred practical operable ratio of sensitizer to resin in the top coat as being between 1:10 and 5:1. The most preferred is between 1:4 and 3:1. In example 1, the ratio is 1:2. The sensitizer is 32% of the solids. A conventional ultraviolet light source is used to expose the plate for 2 minutes through a conventional negative film. U.S. Pat. No. 4,299,905 claims a photosensitive layer for a water developable lithographic printing plate which layer consists of a liquid epoxy resin and a diazonium salt. The sensitizer is between 40 and 70% of the solids. In example 1, the sensitizer is 40% of the solids. It is condensed p-diazodiphenyl formaldehyde p-toluenesulfonate. A conventional ultraviolet light source is used to expose the plate for 1 minute through a conventional negative film. The plate gave no sign of wear after 75,000 impressions. U.S. Pat. No. 4,576,892 claims a high exposure sensitive lithographic printing plate which comprises a metal substrate with an overlying layer comprising a diazonium salt which has undergone a treatment prior to imagewise exposure. The treatment comprises heating, UV exposing, laser exposing, or electron beam exposing. The heat treatment is performed for a duration between 1 and 150 hours at a temperature between 35 and 120° C. In example 1, the ratio of sensitizer to resins is 2:9. The sensitizer is 18% of the solids. The diazonium salt is heat treated for 30 hours at 60° C. The resins are epoxy and polyurethane resins. The plate is exposed by projection for 10 seconds. The plate ran to 10,000 acceptable impressions.

The present invention provides a photosensitive element composed of a sheet substrate having an actinic radiation sensitive imageable layer coated the substrate. The imageable layer has an admixture an aromatic diazonium salt, and a solid epoxy polymer. It has been unexpectedly found that the imageable layer is sensitive to low levels of actinic irradiation, namely, from about 2 and 20 mj/cm² in the UV region. The sensitivity is increased by heating the imageable layer before development. After imagewise exposure and aqueous development, an imaged element is obtained, which is useful for lithographic printing.

### SUMMARY OF THE INVENTION

The invention provides an actinic radiation sensitive composition comprising in admixture an aromatic diazonium salt having an anion, and having a weight average molecular weight of from about 15,000 to about 35,000, said aromatic diazonium salt being present in an amount of from about 1 weight % to about 9 weight % of said composition; and a solid epoxy polymer having a weight average molecular weight of from about 2,000 to about 8,000.

The invention also provides a photosensitive element which comprises a sheet substrate having coated thereon an actinic radiation sensitive imageable layer, said imageable layer comprising in admixture an aromatic diazonium salt having an anion, and having a weight average molecular weight of from about 15,000 to about 35,000, said aromatic diazonium salt being present in an amount of from about 1 weight % to about 9 weight % of said imageable layer; and a solid epoxy polymer having a weight average molecular weight of from about 2,000 to about 8,000.

The invention also provides a method for producing an imaged photosensitive element which comprises
a) providing a photosensitive element which comprises a sheet substrate having coated thereon an actinic radiation sensitive imageable layer, said imageable layer comprising in admixture an aromatic diazonium salt having an anion, and having a weight average molecular weight of from about 15,000 to about 35,000, said aromatic diazonium salt being present in an amount of from about 1 weight % to about 9 weight % of said imageable layer; and a solid epoxy polymer having a weight average molecular weight of from about 2,000 to about 8,000;
b) imagewise exposing the photographic element to actinic radiation to thereby produce exposed image areas and unexposed nonimage areas;
c) removing the unexposed nonimage areas with a liquid developer.

The invention further provides a method for producing an imaged photosensitive element which comprises
a) providing a photosensitive element which comprises a sheet substrate having coated thereon an actinic radiation sensitive imageable layer, said imageable layer comprising in admixture an aromatic diazonium salt having an anion, and having a weight average molecular weight of from about 15,000 to about 35,000, said aromatic diazonium salt being present in an amount of from about 1 weight % to about 9 weight % of said imageable layer; and a solid epoxy polymer having a weight average molecular weight of from about 2,000 to about 8,000;
b) imagewise exposing the photographic element to actinic radiation to thereby produce exposed image areas and unexposed nonimage areas;
c) heating the imagewise exposed photographic element at a temperature of from about 90° C. to about 150° C. for from about 10 seconds to about 120 seconds;
d) removing the unexposed nonimage areas with a liquid developer.

### DETAILED DESCRIPTION OF THE INVENTION

The first component of the inventive composition is an aromatic diazonium salt. Typical diazonium salts in an imageable layer for a conventional negative working plate have a molecular weight between about 300 and about 10,000. For example, typical monomeric diazonium salts, such as 2,5-diethoxy-4(4′-tolylthio)-benzenediazonium fluoroborate, have a molecular weight of about 400; typical polymeric diazonium salts, such as 4-diazodiphenylamine sulphate, condensed with formaldehyde have a molecular weight of about 2,000; and typical polymeric diazonium salts, such as 4-diazo-3-methoxydiphenylamine sulphate, condensed with 1,1′-oxybis[4-(methoxymethyl)benzene] have a molecular weight of about 10,000. It has been found that a diazonium salt with a higher molecular weight, namely, of about 15,000 and above, considerably increases the apparent photosensitivity of the imageable layer. Diazonium salts with a molecular weight above about 35,000 give an imageable layer that is difficult to develop. Therefore, the diazonium salt in the present invention has a weight average molecular weight of from about 15,000 to about 35,000, preferably from about 20,000 to about 30,000, most preferably from about 20,000 to about 25,000.

The content of typical diazonium salts in an imageable layer for a conventional negative-working plate is between 10 and 35 weight %. It has been found that a lower content of the diazonium salt considerably increases the apparent photosensitivity of the imageable layer. The diazonium salt in the present invention has a content of from about 1 weight % to about 9 weight %, preferably from about 2 weight % to about 8% weight %, and more preferably from about 3 weight % to about 8% weight % based on the weight of the overall composition.

An aromatic diazonium salt having an alkoxy substituent is preferred. The most preferred aromatic diazonium salt is derived from a 2-methoxy-4-(phenylamino)benzenediazonium salt and 1,1′-oxybis[4-(methoxymethyl)benzene]. The mole ratio of 2-methoxy-4-(phenylamino)benzenediazonium salt to 1,1′-oxybis[4-(methoxymethyl)benzene] can be varied. The preferred ratio is 1:>1, such as 1:1.4. The anion, namely the counter ion to the aromatic diazonium salt, is an ion of any corresponding acid whose pH is less than three. The anion must have a low nucleophilicity to promote polymer chain growth rather than chain termination. Preferred anions include trifluoromethanesulfonate, trichloroacetate, tetrafluoroborate, hexafluoroarsenate, hexafluoroantimonate, and hexafluorophosphate. The most preferred anions include tetrafluoroborate, hexafluoroantimonate, and hexafluorophosphate. It is believed that the diazonium salt upon ultraviolet exposure of the imageable layer yields an acid which initiates the polymerization of the solid epoxy resin.

The composition also has a solid epoxy polymer. It has been found that epoxy polymers with a molecular weight below about 2,000 give an imageable layer that has poor resistance to printing inks. It has been found that epoxy polymers with a weight average molecular weight above about 8,000 give an imageable layer that is difficult to develop. Therefore, the imageable layer requires an epoxy polymer with a weight average molecular weight of from about 2,000 to about 8,000, preferably from about 3,000 to about 7000, most preferably about 3,000 to about 6000. The preferred epoxy polymer has an epoxide equivalent weight of from about 1,000 to about 4,000, and a hydroxyl content of about 0.2 equivalents per 100 grams or greater. The melting point for such epoxy polymers is from about 90° C. to about 160° C. The glass transition temperature is about 68° C. A preferred solid epoxy polymers is a moderately high molecular weight polymer (CAS Registry Number 25036-25-3) derived from 4,4′-(1-methylethylidene)bisphenol and 2,2′-[(1-methylethylidene)bis(4, 1-phenyleneoxymethylene)]bis(oxirane). The solid epoxy polymer has a content of from about 40 weight % to about 95 weight %, preferably from about 55 weight % to about 85 weight % based on the weight of the overall composition.

The composition may also comprise additional optional components which are well known in the art. Such include plasticizers, adhesion promoters, pigments, dyes, surfactants, sensitizers, exposure indicators, and stabilizers. The type and quantity of such additives depends upon the purpose of the additive. Care must be taken that the additive does not appreciably reduce the practical light-sensitivity of the composition. For example, a colorant is preferred which can serve to increase the apparent contrast and to also harden the layer. The colorant is preferably a pigment which does not absorb an excessive proportion of the actinic light required for the imageable layer. Colorants employable in the coating composition include all those listed in the Color Index which do not substantially interfere with the mechanism of the coating layer. Colorants useful herein include dyes such as Rhodamine, Calcozine, Victoria Blue and methyl violet, and such pigments as the anthraquinone and phthalocyanine types. Generally, the colorant is present in the form of a pigment dispersion which may comprise a mixture of one or more pigments and/or one or more dyes dispersed in a suitable solvent or mixture of solvents. The colorant is preferably present in an amount of from about 3 weight % to about 15 weight %, more preferably from about 5 weight % to about 10 weight % and most preferably from about 6 weight % to about 8 weight % based on the weight of the overall composition.

Suitable acid stabilizers useful within the context of this invention include phosphoric, citric, benzoic, m-nitro benzoic, p(p-anilino phenylazo)benzene sulfonic acid, 4,4′-dinitro-2,2,-stilbene disulfonic, itaconic, tartaric, 1,2-cyclohexanedicarboxylic acid, and p-toluene sulfonic acid and mixtures thereof. Preferably, the acid stabilizer is phosphoric acid. When the acid stabilizer is present in the radiation-polymerizable composition it is preferably present in the amount of from about 0.02% to about 2.0% by weight of the composition, and most preferably from about 0.05% to about 1.0%, although the skilled artisan may use more or less as desired. Exposure indicators (or photoimagers) which may be useful in conjunction with the present invention include 4-phenylazodiphenylamine, eosin, azobenzene, Calcozine Fuchsine dyes, and Crystal Violet, Crystal Violet lactone and Methylene Blue dyes. Preferably, the exposure indicator is 4-phenylazodiphenylamine. The exposure indicator, when one is used, is preferably present in the composition in an amount of from about 0.01% to about 1% by weight. A more preferred range is from about 0.02% to about 0.5% and, most preferably, the exposure indicator is present in an amount of from about 0.02% to about 0.3%, although the skilled artisan may use more or less as desired.

Surfactants can include anionic, cationic, nonionic and amphoteric surfactants in minor amounts which can be determined by those skilled in the art. Plasticizers can include phthalates surfactants in minor amounts which can be determined by those skilled in the art.

In order to form a coating composition for the production of photographic elements, the composition of this invention may be dissolved in admixture in a solvent or mixture of solvents to facilitate application of the composition to the substrate. Suitable solvents for this purpose include water, 2-butanone, 1-methoxy-2-propanol, N,N-dimethylformamide, tetrahydrofuran, butyrolactone, glycol ethers such as propylene glycol monomethyl ether and methyl Cellosolve, alcohols such as ethanol and n-propanol, and ketones such as methyl ethyl ketone, or mixtures thereof. Organic solvents are preferred. Preferably, the solvent comprises a mixture of 2-butanone, 1-methoxy-2-propanol, and N,N-dimethylformamide. In general, the solvent is usually employed in an excess since it is evaporated from the coating composition once it is applied to an appropriate substrate, however, some insignificant amount of solvent may remain as residue. The composition forms the imageable layer of the present invention by being applied to a substrate using the application methods known in the art. These include dipping, spraying, roller coating and meniscus coating, followed by evaporation of the solvent composition. The dried coating weight per area is from about 0.3 to about 0.9 g/m², preferably from about 0.4 to about 0.8 g/m², most preferably from about 0.4 to about 0.7 g/m².

The substrate of the photographic element is typically a dimensionally stable sheet, including metals and plastics. Suitable substrates include any sheet material conventionally used to prepare lithographic printing plates. A lithographic printing plate, preferably comprises a sheet metal substrate such as zinc, copper or most preferably aluminum and the alloys thereof, especially those aluminum compositions suitable for the manufacture of lithographic printing plates such as Alcoa 3003 and Alcoa 1100. The surface of the aluminum sheet may be treated with metal finishing techniques known in the art, including physical roughening, electrochemical roughening, chemical roughening, anodizing, and silicate sealing and the like. If the surface is roughened, the average roughness (Ra) is preferably in the range from 0.1 to 0.8 um, and more preferably in the range from about 0.1 to about 0.4 um. The preferred thickness of the aluminum sheet is in the range from about 0.005 inch to about 0.020 inch. The preferred aluminum sheet is roughened and anodized, such as commonly used for lithographic printing plates. In the production of photographic elements such as lithographic printing plates, an aluminum substrate is first preferably grained by art recognized methods such as by means of a wire brush, a slurry of particulates or by chemical or electrochemical means, for example in an electrolytic solution comprising hydrochloric acid by methods well known in the art. Anodization can be done with sulfuric acid, phosphoric acid, or a combination of such acids. Other conventional anodization methods can also be used in the preparation of the anodized substrate for the present invention.

The surfaces of the substrate can be subjected to a treatment after anodization, if necessary, using the surface treatment techniques known in the art to improve adhesion between the substrate and organic coating, to enhance the developability of the imagewise unexposed areas, or to increase the hydrophilic nature of the surface. Interlayer compositions employable in the practice of this invention include aqueous solutions of alkali silicate such as sodium silicate, silicic acid, polyvinyl phosphonic acid, the Group IV-B metal fluorides, polyacrylic acid, the alkali zirconium fluorides, such as, potassium zirconium hexafluoride, or hydrofluozirconic acid in concentrations of 0.5% to 20% by volume coated by spraying, brushing, dipping or other equivalent means.

The photosensitive element of the present invention can further have an overlying layer. A possible function of an overlying layer is to prevent damage, such as scratching, of the surface layer of the imageable element during handling prior to imagewise exposure. The overlying layer should be soluble, dispersible, or at least permeable in an aqueous prewash or developer.

The thus prepared photosensitive element is exposed to actinic radiation by means well known in the art. Such exposure may be conducted by exposure to actinic radiation from a light source through a conventional halftone negative film under vacuum frame conditions. Mercury vapor discharge lamps or metal halide lamps can be used. Other radiation sources, such as carbon arc, pulsed xenon, and lasers, may also be used. Light absorbing filters may be used to reduce light scattering in the imageable layer. The amount of optimum conventional ultraviolet exposure is from about 1 millijoules/cm² to about 40 millijoules/cm², preferably from about 2 millijoules/cm² to about 20 millijoules/cm², most preferably from about 3 millijoules/cm² to about 10 millijoules/cm².

It has been surprisingly found that a heating treatment of the imageable layer before development increases the apparent sensitivity. The heat treatment is preferably after the UV image exposure. The temperature of the heat treatment is preferably from about 5° C. to about 30° C., more preferably from about 10° C. to about 20° C. below the fog point of the imageable layer. Thus heating may be conducted at a temperature of from about 90° C. to about 150° C., more preferably from about 110° C. to about 120° C. Heating is done for from about 10 seconds to about 120 seconds, or preferably from about 30 seconds to about 60 seconds. For example, the energy that is required to make an acceptable image with a post-exposure heat treatment at 120° C. is approximately half of that for an acceptable image without a heat treatment.

The printing plates are prepared in a customary processing manner. The nonimage areas of the layer, which have retained their solubility, are removed by treatment with a suitable developer, such as, an aqueous acidic, basic, or neutral solution. The preferred developer comprises water, organic alcohol, and surfactant. The exposed image areas remain on the substrate. Surprisingly, it has been found that less than about 5 weight % of the exposed image is lost during development. In comparison, the exposed image areas of typical conventional negative-working plates lose from about 5 weight % to about 20 weight %.

After development, the printing plate is usually treated with a finisher such as gum Arabic. A post-development baking treatment can be used, if desired, to increase run length of the plate on press. The temperature of the baking treatment is above the fog point, preferably above the melting point of the solid epoxy resin. This temperature is typically from about 90° C. to about 300° C., preferably from about 130° C. to about 200° C. The dwell time of the baking temperature is typically from about 10 seconds to about 120 seconds, or preferably from about 30 seconds to about 60 seconds to ensure uniform heating across the plate.

The following non-limiting examples serve to illustrate the invention.

### EXAMPLE 1

A photosensitive composition was prepared as follows. Epon 1007F (3.28 g), NW 1440 PF6 (0.32 g), and Chip 79S26C (0.40 g) were formulated into a solvent mix of 2-butanone (45 g), 1-methoxy-2-propanol (36 g), and N,N-dimethylformamide (15 g). Epon 1007F is a moderately high molecular weight solid epoxy resin available from Shell. It is derived from 4,4′-(1-methylethylidene)bisphenol and 2,2′-[(1-methylethylidene)bis(4, 1-phenyleneoxymethylene)]bis(oxirane). It has a molecular weight of about 4,000. It has an epoxide equivalent weight between 1,700 and 2,300. It has a melting point between 120° C. and 130° C. NW 1440 PF6 is a benzenediazonium hexafluorophosphate polymer available from Clariant. It is derived from 2-methoxy-4-(phenylamino)benzenediazonium sulfate and 1,1′-oxybis[4-methoxymethyl)benzene] in a 1:1.4 mole ratio, plus potassium hexafluorophosphate. It has a molecular weight of about 20,000. It has a peak decomposition temperature between 180° C. and 185° C. Chip 79S26C is a pigment chip available from Penn Color. It consists of a phthalocyanine pigment with a polyvinyl butyral binder in a 6:4 ratio.

The photosensitive composition at 4% solids was applied to a lithographic aluminum plate substrate to provide an imageable layer with a coating weight of 0.60 g/m² after drying. Prior to application of the photosensitive coating, the aluminum substrate was mechanically roughened, anodized in sulfuric acid, and post-anodically treated with an aqueous silicate solution.

The photosensitive plate was exposed for 10 millijoules/cm² through a negative 6 lines/mm (150 lines/inch) screened Ugra Plate Control Wedge 1982, using a metal halide lamp. It was developed for 24 seconds at 25° C., using an aqueous solution containing Petro LBA (13%, available from Witco), benzyl alcohol (6.5%), and sodium sulfite (2%). It was subsequently rinsed with water, rubbed with a finisher containing dextrin (10%) and Petro LBA (4.5%), and then dried. The continuous tone wedge image was a solid 3 and ghost 5. The dot reproduction was from 2 to 98%. Microlines 6 and higher were resolved.

### EXAMPLE 2

A photosensitive plate identical to the one in Example 1 was exposed with a UV laser in an alfaQuest FasTRAK CTP/C at a resolution of 40 dots per mm (1016 dots per inch). The exposure amount was 8 millijoules/cm². After processing, the wedge image was a solid 2 and ghost 4. The plate on press gave no sign of wear after 34,000 printed impressions.

### EXAMPLE 3

A photosensitive plate identical to the one in Example 1 was exposed similar to that in Example 2 but with an exposure amount of 12 millijoules/cm². After processing, the continuous wedge image was a solid 3 and ghost 5. The plate gave no sign of wear after 75,000 printed impressions.

### EXAMPLE 4

A photosensitive plate was prepared as that in Example 3 with the additional step of baking at 200° C. for 90 sec after finisher treatment. The plate gave no sign of wear after 75,000 printed impressions.

### EXAMPLE 5

A photosensitive plate identical to the one in Example 1 was exposed with a UV laser in a PerkinElmer ProForm Metro at a resolution of 50 dots per mm (1270 dots per inch). The exposure amount was 10 millijoules/cm². After processing, the wedge was a solid 2 and ghost 4. The dot reproduction was from 5 to 95%.

### EXAMPLE 6

A photosensitive plate was prepared like the one in Example 1 with the polyvinyl butyral binder in Chip 79S26C replaced with Epon 1007F. The plate was exposed and developed in a manner similar to that in Example 1. The continuous tone wedge image was a solid 4 and ghost 6. The dot reproduction was from 2 to 98%. Microlines 6 and higher were resolved.

### EXAMPLE 7

A photosensitive plate was prepared like the one in Example 1 with the epoxy resin replaced with Epon 1009F, which is a high molecular weight solid resin, available from Shell. It has a molecular weight of about 6,100. It has an expoxide equivalent weight between 2,300 and 3,800. It has a melting point between 130° C. and 140° C. The plate was exposed and developed for 60 seconds similarly to that in Example 1. The continuous tone wedge image was a solid 4 and ghost 8. The dot reproduction was from 2 to 98%. Microlines 6 and higher were resolved.

### COMPARATIVE EXAMPLE A

A photosensitive plate was prepared like the one in Example 1 with the diazonium salt replaced with 2-methoxy-4-(phenylamino)benzenediazonium hydrogensulfate, which has a molecular weigh of 323. It was exposed and developed similar to that in Example 1. No image remained on the plate after development.

### COMPARATIVE EXAMPLE B

A photosensitive plate was prepared like the one in Example 1 with the diazonium salt replaced with a diazonium salt derived from 2-methoxy-4-(phenylamino)benzenediazonium sulfate condensed with formaldehyde as the tosylate salt. The diazonium salt has a molecular weight of about 2,000. The plate was exposed and developed similarly to that in Example 1. The continuous tone wedge image had no solid step. The ghost step was 4. The dot reproduction was poorer, from 5 to 98%. Microlines below 20 were not resolved.

### COMPARATIVE EXAMPLE C

A photosensitive plate was prepared like the one in Example 1 but without the diazonium salt in the photosensitive composition. The epoxy resin was increased correspondingly, namely, to 90 weight % (3.6 g). It was exposed and developed similarly to that in Example 1. The exposed and nonexposed areas of the photosensitive coating did not come off during development.

### COMPARATIVE EXAMPLE D

A photosensitive plate was prepared like the one in Example 1 with the diazonium salt increased to 25 weight % (1 g) of the photosensitive composition, with the epoxy resin decreased correspondingly, namely, to 65 weight % (2.6 g). The plate was exposed and developed similarly to that in Example 1. The continuous tone wedge image was a solid 1 and ghost 3. The dot reproduction was poorer, from 4 to 98%. Microlines below 15 were not resolved.

### COMPARATIVE EXAMPLE E

A photosensitive plate was prepared like the one in Example 1 with the epoxy resin replaced with Epon 100F, which is a low molecular weight solid resin, available from Shell. The resin has a molecular weight of about 1075. It has an epoxide equivalent weight between 525 and 550. It has a melting point between 75 and 80° C. It is derived from 4,4′-(1-methylethylidene)bisphenol and 2,2′-[(1-methylethylidene)bis(4,1-phenyleneoxymethylene)]bis(oxirane). The plate was exposed and developed similarly to that in Example 1. No image remained on the plate after development.

### COMPARATIVE EXAMPLE F

A photosensitive plate was prepared like the one in Example 1 with the epoxy resin replaced on a solid basis with Eponol 53-BH-35, which is an ultrahigh molecular weight solid resin, at 35 weight % in a 75:25 solvent blend of methyl ethyl ketone and propylene glycol methyl ether. The resin solution is available from Shell. It has a molecular weight of about 30,000. It is derived from 4,4′-(1-methylethylidene)bisphenol and 2,2′-[(1-methylethylidene)bis(4,1-phenyleneoxymethylene)]bis(oxirane). The plate was exposed and developed similarly to that in Example 1. The exposed and nonexposed areas of the photosensitive coating did not come off during development.

### COMPARATIVE EXAMPLE G

A photosensitive plate was prepared like the one in Example 1 with the coating weight increased to 2 g/m². The plate was exposed and developed similarly to that in Example 1. The continuous tone wedge image had no solid step. The ghost step was 3. The dot reproduction was poorer, from 20 to 98%. Microlines below 30 were not resolved.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. An actinic radiation sensitive composition comprising in admixture an aromatic diazonium salt having an anion, and having a weight average molecular weight of from about 15,000 to about 35,000, said aromatic diazonium salt being present in an amount of from about 1 weight % to about 9 weight % of said composition; and a solid epoxy polymer having a weight average molecular weight of from about 2,000 to about 8,000.

2. The composition of claim 1 wherein said epoxy polymer is present in an amount of from about 40 weight % to about 95 weight % of said composition.

3. A photosensitive element which comprises a sheet substrate having coated thereon an actinic radiation sensitive imageable layer, said imageable layer comprising in admixture an aromatic diazonium salt having an anion, and having a weight average molecular weight of from about 15,000 to about 35,000, said aromatic diazonium salt being present in an amount of from about 1 weight % to about 9 weight % of said imageable layer; and a solid epoxy polymer having a weight average molecular weight of from about 2,000 to about 8,000.

4. The photosensitive element of claim 3 wherein said imageable layer has a dry coating weight of from about 0.3 g/m² to about 0.9 g/m².

5. The photosensitive element of claim 3 wherein said epoxy polymer is present in an amount of from about 40 weight % to about 95 weight % of said imageable layer.

6. The photosensitive element of claim 3 wherein said sheet substrate is comprised of aluminum.

7. The photosensitive element of claim 3 wherein said sheet substrate is comprised of aluminum and has a surface adjacent to the imageable layer which has been anodized.

8. The photosensitive element of claim 3 wherein said sheet substrate is comprised of aluminum and has a surface adjacent to the imageable layer which has been grained.

9. The photosensitive element of claim 3 wherein said sheet substrate is comprised of aluminum and has a surface adjacent to the imageable layer which has a hydrophilic interlayer.

10. The photosensitive element of claim 3 wherein said sheet substrate is comprised of aluminum and has a surface adjacent to the imageable layer which has a hydrophilic interlayer wherein said hydrophilic interlayer comprises an alkali silicate.

11. The photosensitive element of claim 3 wherein said diazonium salt is derived from a 2-methoxy-4-(phenylamino)benzenediazonium salt and 1,1′-oxybis[4-methoxymethyl)benzene].

12. The photosensitive element of claim 3 wherein said diazonium salt is derived from a 2-methoxy-4-(phenylamino)benzenediazonium salt and 1,1′-oxybis[4-methoxymethyl)benzene]and wherein the mole ratio of said 2-methoxy-4-(phenylamino)benzenediazonium salt to said 1,1′-oxybis[4-methoxymethyl)benzene] is 1:>1.

13. The photosensitive element of claim 3 wherein said diazonium salt has an anion selected from the group consisting of hexafluorophosphate, hexafluoroantimonate, and tetrafluoroborate.

14. The photosensitive element of claim 3 wherein said solid epoxy polymer is derived from 4,4′-(1-methylethylidene)bisphenol and 2,2′-[(1-methylethylidene)bis(4,1-phenyleneoxymethylene)]bis(oxirane).

15. The photosensitive element of claim 3 wherein said solid epoxy polymer has a hydroxyl content of about 0.2 equivalents/100 grams or greater.

16. The photosensitive element of claim 3 wherein said solid epoxy polymer has an epoxide equivalent weight of from about 1,000 to about 4,000.

17. A method for producing an imaged photosensitive element which comprises
a) providing a photosensitive element which comprises a sheet substrate having coated thereon an actinic radiation sensitive imageable layer, said imageable layer comprising in admixture an aromatic diazonium salt having an anion, and having a weight average molecular weight of from about 15,000 to about 35,000, said aromatic diazonium salt being present in an amount of from about 1 weight % to about 9 weight % of said imageable layer; and a solid epoxy polymer having a weight average molecular weight of from about 2,000 to about 8,000;
b) imagewise exposing the photographic element to actinic radiation to thereby produce exposed image areas and unexposed nonimage areas;
c) removing the unexposed nonimage areas with a liquid developer.

18. The method of claim 17 wherein said imageable layer has a dry coating weight of from about 0.3 g/m² to about 0.9 g/m².

19. The method of claim 17 wherein said epoxy polymer is present in an amount of from about 40 weight % to about 95 weight % of said imageable layer.

20. The method of claim 17 further comprising the subsequent step of baking the imagewise exposed and developed photosensitive element at a temperature of from about 90° C. to about 300° C. for from about 10 seconds to about 120 seconds.

21. A method for producing an imaged photosensitive element which comprises
a) providing a photosensitive element which comprises a sheet substrate having coated thereon an actinic radiation sensitive imageable layer, said imageable layer comprising in admixture an aromatic diazonium salt having an anion, and having a weight average molecular weight of from about 15,000 to about 35,000, said aromatic diazonium salt being present in an amount of from about 1 weight % to about 9 weight % of said imageable layer; and a solid epoxy polymer having a weight average molecular weight of from about 2,000 to about 8,000;
b) imagewise exposing the photographic element to actinic radiation to thereby produce exposed image areas and unexposed nonimage areas;
c) heating the imagewise exposed photographic element at a temperature of from about 90° C. to about 150° C. for from about 10 seconds to about 120 seconds;
d) removing the unexposed nonimage areas with a liquid developer.

22. The method of claim 21 wherein said imageable layer has a dry coating weight of from about 0.3 g/m² to about 0.9 g/m².

23. The method of claim 21 wherein said epoxy polymer is present in an amount of from about 40 weight % to about 95 weight % of said imageable layer.

24. The method of claim 21 further comprising the subsequent step of baking the imagewise exposed and developed photosensitive element at a temperature of from about 90° C. to about 300° C. for from about 10 seconds to about 120 seconds.

25. The method of claim 21 wherein the imagewise exposing is conducted with ultraviolet radiation.

26. The method of claim 21 wherein the imagewise exposing is conducted with ultraviolet radiation in an amount of from about 1 mj/cm² to about 40 mj/cm².
